(19) United States
(12) Patent Application Publication
(10) Pub. No.: US 2023/0192056 A1
(43) Pub. Date: Jun. 22, 2023

(54) HYDRAULIC MOTOR VEHICLE BRAKE SYSTEM

(71) Applicant: ZF Active Safety GmbH, Koblenz (DE)

(72) Inventor: Nicholas Alford, Waldesch (DE)

(21) Appl. No.: 18/079,557

(22) Filed: Dec. 12, 2022

(30) Foreign Application Priority Data
Dec. 21, 2021 (DE) 102021134166.3

(51) Int. Cl. B60T 13/74; B60T 13/68; B60T 7/04

(52) U.S. Cl. CPC B60T 13/745; B60T 13/686; B60T 7/04; B60T 2270/402; B60T 2270/82; B60T 2270/413

(57) ABSTRACT

A hydraulic motor vehicle brake system that is operable in a brake-by-wire mode and/or a push-through mode is disclosed. The brake system comprises: a pedal module having a master cylinder which, in the push-through mode, is actuatable by a driver by way of a pedal in order to generate a respective brake pressure at wheel brakes of the motor vehicle; and a functional module having at least one electrical brake pressure generator by which, in the brake-by-wire mode, a respective brake pressure can be generated at the wheel brakes. The pedal module and the functional module are arranged separately from one another and are couplable and/or coupled to one another via lines, such as fluid lines.

### CROSS-REFERENCE TO RELATED APPLICATION

This application claims priority to German Priority Application No. 102021134166.3, filed Dec. 21, 2021, the disclosure of which is incorporated herein by reference in its entirety.

### TECHNICAL FIELD

The disclosure relates to a hydraulic motor vehicle brake system, in particular for a motor vehicle.

### BACKGROUND

Motor vehicle brake systems for autonomous or partially autonomous driving must be of redundant design, because it cannot be assumed here that the driver is situated in the vehicle or that the driver can actuate a brake pedal for so-called push-through operation without delay, for example if their view is averted from the traffic situation. It is therefore stipulated that brake systems for autonomous or partially autonomous driving have functional units that implement an activatable main braking function and, in a redundant manner, an electrically activatable auxiliary braking function.

For example, U.S. Pat. No. 9,827,960 B2 describes a hydraulic motor vehicle brake system which can be operated in a brake-by-wire mode and which has a master brake cylinder, which is actuatable by a brake pedal, and a first electrically controllable pressure provision device. Aside from the first electrically controllable pressure provision device for pressurizing the wheel brakes in the brake-by-wire operating mode, a second electrically controllable pressure provision device is provided which has a suction connection and a pressure connection, wherein the suction connection is connected to the pressure medium reservoir and the pressure connection is connected to at least one wheel brake without the interposition of a valve.

The arrangement of all functional units within one housing block (“single box design”), as is the case in U.S. Pat. No. 9,827,960 B2, however has certain disadvantages. Firstly, there is an increased space requirement in critical regions of the vehicle, and secondly, the functional units cannot be individually or arbitrarily expanded in order to increase functionality or make different and individual vehicle configurations possible. Furthermore, a single-box architecture entails more difficult production and thus higher production costs.

### SUMMARY

The disclosure is based on structurally and/or functionally improving a hydraulic motor vehicle brake system as mentioned in the introduction.

In one exemplary arrangement, a hydraulic motor vehicle brake system may be for a motor vehicle. The motor vehicle may be a passenger motor vehicle or a heavy goods vehicle. The motor vehicle and/or the hydraulic motor vehicle brake system may have wheel brakes, such as front-wheel brakes and/or rear-wheel brakes. The hydraulic motor vehicle brake system may be for redundant brake pressure control and/or may have this and/or be configured for this.

The hydraulic motor vehicle brake system may be operable in and/or configured for a brake-by-wire mode and/or a push-through mode.

The hydraulic motor vehicle brake system may comprise a pedal module. The pedal module may have a master cylinder. The pedal module may have a brake pedal. The brake pedal may be couplable and/or coupled to the master cylinder, for example by a force input element. The master cylinder may, in the push-through mode, be actuatable by a driver by way of the pedal in order to generate a respective brake pressure at wheel brakes of the motor vehicle.

The hydraulic motor vehicle brake system may comprise a functional module, for example pressure modulation module. The functional module may have at least one electrical brake pressure generator. By operation of the at least one electrical brake pressure generator of the functional module, it may be possible for a respective brake pressure to be generated at the wheel brakes in the brake-by-wire mode. The functional module may have a first functional unit and a second functional unit. The first functional unit may have at least one electrical brake pressure generator. The second functional unit may have at least one electrical brake pressure generator. The first functional unit and the second functional unit may be couplable and/or coupled to one another in terms of action, for example in order to respectively and/or simultaneously and/or redundantly generate a brake pressure at the wheel brakes.

The hydraulic motor vehicle brake system may be configured to detect, by a sensor, a vehicle deceleration demanded by the driver by way of the brake pedal, and/or to convert said demanded vehicle deceleration into an activation signal for the at least one electrical brake pressure generator of the functional module.

In the event of a failure of the at least one electrical brake pressure generator of the functional module, a brake pressure can be built up at the wheel brakes by the master cylinder of the pedal module by virtue of hydraulic fluid being conveyed from the master cylinder of the pedal module to the wheel brakes. In a normal braking mode, the brake pedal may be decoupled from the master cylinder of the pedal module, wherein a brake pressure is built up at the wheel brakes by the electrical brake pressure generator of the functional module. By contrast, in the emergency braking mode, that is to say for example in the event of failure of the at least one electrical brake pressure generator of the functional module, the decoupling of brake pedal and master cylinder of the pedal module may be eliminated. In this case, the driver can themself then generate a brake pressure at the wheel brakes by the brake pedal, which then acts on the master cylinder of the pedal module. The emergency braking mode may be referred to as push-through mode owing to the elimination of the decoupling of the brake pedal and master cylinder of the pedal module. The ability granted to the driver of being able to build up a brake pressure at the wheel brakes by way of the master cylinder of the pedal module in the push-through mode creates a redundancy, which is imperative from a safety aspect.

The pedal module and the functional module may be arranged separately and/or distinctly from one another. The pedal module and the functional module may be couplable and/or coupled to one another via lines, such as fluid lines. For this purpose, the pedal module and the functional module may have suitable connectors. The pedal module may be accommodated entirely or at least partially in a first housing block. The functional module may be accommodated entirely or at least partially in a second housing block, which differs and/or is separate from the first housing block. The functional module and/or the second housing block may comprise connectors for the wheel brakes. The pedal module and the functional module may be arranged separately and/or distinctly and/or so as to be spaced apart from one another in the motor vehicle. The pedal module and the functional module may be arranged in decentralized fashion. The pedal module and the functional module may be arranged decentrally in the motor vehicle. The pedal module may be arranged adjacent to and/or in the vicinity of the footwell of the driver, for example such that the brake pedal projects into the footwell of the driver. The functional module may be arranged at some other location that is not adjacent to the footwell of the driver. For example, the functional module may be arranged adjacent to and/or in the vicinity of the footwell of the front passenger, or further rearwards towards, or in, the rear end of the motor vehicle. The functional module may be arranged so as to act between the pedal module and the wheel brakes.

The master cylinder of the pedal module may be a brake cylinder, such as a master brake cylinder. The master cylinder of the pedal module may have a piston-cylinder arrangement. The piston-cylinder arrangement may be configured as a tandem piston-cylinder arrangement. The piston-cylinder arrangement may be configured as a single-acting or double-acting piston-cylinder arrangement.

The master cylinder of the pedal module may have a first pressure chamber. The master cylinder of the pedal module may have a piston, such as a first piston and/or input piston. The piston may be adjustable. The piston may be adjustable and/or actuatable, or adjusted and/or actuated, by the brake pedal. The first pressure chamber of the master cylinder of the pedal module may be delimited by the piston, such as the input piston. The master cylinder of the pedal module may have a second pressure chamber. The master cylinder of the pedal module may have a further piston, such as a second piston and/or output piston. The piston may be adjustable. The piston may be adjustable and/or actuatable, or adjusted and/or actuated, by the actuating device and/or by the first piston, such as the input piston. The first pressure chamber of the piston-cylinder arrangement may be delimited by the first piston or input piston and the second piston or output piston. The second pressure chamber of the piston-cylinder arrangement may be delimited by the second piston or output piston. The first pressure chamber may be couplable and/or coupled to a brake circuit, such as a first brake circuit. The second pressure chamber may be couplable and/or coupled to a brake circuit, such as a second brake circuit. The pedal module may have a first outlet for the first brake circuit and a second outlet for the second brake circuit. The pressure chambers may be connected to the respective outlet via fluid lines.

The pedal module may have a pedal simulator arrangement. The pedal simulator arrangement may be connected to the master cylinder of the pedal module. The pedal simulator arrangement may be an/or have a simulator, such as a pedal simulator. The pedal simulator arrangement may have a spring-piston device. The pedal simulator arrangement may have a pressure chamber. The pressure chamber of the pedal simulator arrangement may be delimited by the piston of the spring-piston device. The piston may be displaceable counter to a spring force of the spring of the spring-piston device. The pressure chamber of the pedal simulator arrangement may receive hydraulic fluid from the master cylinder. The pedal simulator arrangement may have a simulator valve, for example a switchable simulator valve. The simulator valve may be configured to be electromagnetically actuatable. The simulator valve may be configured to switch between two positions. The pedal simulator arrangement may be connected via a fluid line to the first pressure chamber of the master cylinder of the pedal module. The simulator valve may be arranged in this fluid line. The pedal simulator arrangement may be configured to convey a pedal reaction behaviour to the driver in the event of hydraulic decoupling of the master cylinder, in particular from the brake circuits, for example in the brake-by-wire mode.

The pedal module may have, or be couplable and/or coupled to, a reservoir, such as a hydraulic fluid reservoir, for storing and/or containing a pressure medium such as hydraulic fluid and/or brake fluid. The pressure medium may be for the brake system and/or the brake circuit. The pressure medium may be held and/or stored in the reservoir at atmospheric pressure or in an unpressurized state or at other pressures. The reservoir may have at least one fluid level sensor for detecting the fluid level of the reservoir. The reservoir may be a fluid reservoir such as a hydraulic fluid reservoir and/or brake fluid reservoir. The reservoir may have a first partial reservoir. The reservoir may have a second partial reservoir. The reservoir may have a third partial reservoir. The reservoir may have a fourth partial reservoir. The partial reservoirs may be hydraulically connected to one another as far as a minimum fill level. The reservoir may have multiple partitions. The partitions may separate the partial reservoirs from one another. If the pressure medium falls below the minimum fill level, the individual partial reservoirs can be decoupled or separated from one another. In this way, a single partial reservoir can be emptied, for example in the event of a leak. In this case, the other partial reservoirs can remain functional and/or be hydraulically decoupled or separated by the partitions.

The first partial reservoir may be connectable and/or connected via a first reservoir line to the first pressure chamber of the master cylinder of the pedal module. The second partial reservoir may be connectable and/or connected via a second reservoir line to the second pressure chamber of the master cylinder of the pedal module. The third partial reservoir may be connectable and/or connected via a third reservoir line to the at least one pressure chamber, for example to a first pressure chamber, of the at least one electrical brake pressure generator of the functional module. The third partial reservoir may, for the return of pressure medium, such as brake fluid, from at least one wheel brake, be connectable and/or connected via the third reservoir line to at least one wheel brake. The third partial reservoir may serve and/or be configured for the return of pressure medium, such as brake fluid, from at least one wheel brake and/or for the drawing-in of pressure medium, such as brake fluid, by the at least one electrical brake pressure generator of the functional module.

The pedal module may comprise a controller, such as a first controller. The controller of the pedal module may be a control unit. The controller of the pedal module may be configured to activate a, for example electrical, brake pressure generator of the pedal module and/or the pedal simulator arrangement of the pedal module and/or one or more valve arrangements and/or valve units of the pedal module, for example during a brake pressure control operation of the pedal module. The controller of the pedal module may be an electronic control unit (ECU).

The controller of the pedal module may be configured to identify a functional failure of the functional module and/or thereupon initiate a switch from the brake-by-wire mode to the push-through mode. The controller of the pedal module may be configured to, in the event of a failure of the functional module, for a switch from the brake-by-wire mode to the push-through mode, switch a valve device, for example a second valve device, of the functional module such that the master cylinder of the pedal module is coupled to the wheel brakes.

The pedal module may be configured to implement a brake pressure at each wheel brake, for example on a wheel-specific basis, in a redundant manner in relation to the functional module.

The pedal module may have an electrical brake pressure generator. The electrical brake pressure generator of the pedal module may be configured to generate a respective brake pressure, for example on a wheel-specific basis, at the wheel brakes. The pedal module and/or the electrical brake pressure generator of the pedal module may be configured to generate a respective brake pressure at the wheel brakes independently of the master cylinder of the pedal module and/or independently of the functional module and/or the electrical brake pressure generator of the functional module.

The electrical brake pressure generator of the pedal module may comprise at least one, for example two, three or four, fluid-conveying device(s), such as (a) piston pump(s) and/or radial piston pump(s) and/or gear pump(s) and/or multi-piston pump(s), which is/are actuatable by an electric motor. The fluid-conveying device of the pedal module may be assigned and/or connected to one or more brake circuits. For example, each brake circuit may be assigned and/or connected to a pump, such as a piston pump and/or radial piston pump and/or gear pump and/or multi-piston pump. The electrical brake pressure generator of the pedal module may comprise at least one single-acting or double-acting cylinder-piston arrangement that is actuatable by an electric motor. The cylinder-piston arrangement of the pedal module may be configured in accordance with the plunger principle. The cylinder-piston arrangement of the pedal module may have one or two pressure chambers, such as cylinder chambers. The cylinder-piston arrangement of the pedal module may have a piston. The piston may be accommodated movably in the pressure chambers of the cylinder-piston arrangement. The piston of the cylinder-piston arrangement may be driven by the electric motor, for example via a mechanism. The mechanism may be configured to convert a rotational movement of the electric motor into a translational movement of the piston.

The electrical brake pressure generator of the functional module may comprise at least one single-acting or double-acting cylinder-piston arrangement that is actuatable by an electric motor. The cylinder-piston arrangement of the functional module may be configured in accordance with the plunger principle. The cylinder-piston arrangement of the functional module may have one or two pressure chambers, such as cylinder chambers. The cylinder-piston arrangement of the functional module may have a piston. The piston may be accommodated movably in the pressure chambers of the cylinder-piston arrangement. The piston of the cylinder-piston arrangement may be driven by the electric motor, for example via a mechanism. The mechanism may be configured to convert a rotational movement of the electric motor into a translational movement of the piston.

The electrical brake pressure generator of the functional module may comprise at least one, for example two, three or four, fluid-conveying device(s), such as (a) piston pump(s) and/or radial piston pump(s) and/or gear pump(s) and/or multi-piston pump(s), which is/are actuatable by an electric motor. The fluid-conveying device of the functional module may be assigned and/or connected to one or more brake circuits. For example, each brake circuit may be assigned and/or connected to a pump, such as a piston pump and/or radial piston pump and/or gear pump and/or multi-piston pump.

The hydraulic motor vehicle brake system and/or the functional module may be configured to generate a respective brake pressure, for example on a wheel-specific basis, at the wheel brakes.

The functional module may have a controller, such as a second controller. The controller of the functional module may be a control unit. The controller of the functional module may be configured to activate the at least one electrical brake pressure generator of the functional module and/or one or more valve arrangements and/or valve units of the functional module, for example during a brake pressure control operation of the functional module. The controller of the functional module may be an electronic control unit (ECU).

The controller of the functional module may be configured to identify a functional failure of the functional module and/or thereupon initiate a switch from the brake-by-wire mode to the push-through mode. The controller of the functional module may be configured to, in the event of a failure of the functional module, for a switch from the brake-by-wire mode to the push-through mode, switch a valve device, for example a second valve device, of the functional module such that the master cylinder of the pedal module is coupled to the wheel brakes.

The controller of the pedal module and the controller of the functional module may be implemented as separate controllers or control units. The controller of the pedal module and the controller of the functional module may be electrically connected to one another.

The functional module may comprise one first valve device per wheel brake, with at least one first valve. The first valve device of the functional module may, in an electrically non-activated state, connect the wheel brake assigned thereto to an outlet of the electrical brake pressure generator of the functional module. The first valve device of the functional module may, in an electrically activated state, separate the wheel brake assigned thereto from the outlet of the electrical brake pressure generator of the functional module.

The functional module may comprise a second valve device with at least one second valve. The second valve device of the functional module may be configured to selectively couple the master cylinder of the pedal module to, or decouple said master cylinder from, the wheel brakes. The second valve device of the functional module may be configured to selectively couple the master cylinder of the pedal module and/or the electrical brake pressure generator of the functional module to the wheel brakes.

The functional module may be configured to generate brake pressure blending and/or wheel blending, for example 1-wheel blending and/or 2-wheel blending and/or 4-wheel blending. This may for example relate to all wheel brakes (4-wheel blending), to only one vehicle axle (2-wheel blending) or to the wheel brakes individually. The functional module may comprise a third valve device with at least one third valve. The third valve device of the functional module may be configured to generate the brake pressure blending and/or wheel blending.

With the disclosure, the space requirement in critical regions of the vehicle can be significantly reduced. The pedal module and/or the functional module can be individually or arbitrarily expanded in order to increase functionality or make different and individual vehicle configurations possible. The production process can be simplified. The production costs can be reduced.

### BRIEF DESCRIPTION OF DRAWINGS

Exemplary arrangements of the disclosure will be described in more detail below with reference to figures, in which, schematically and by way of example:

FIG. 1 shows a pedal module;

FIG. 2 shows a functional module;

FIG. 3 shows a further variant of a pedal module; and

FIG. 4 shows a further variant of a functional module.

### DETAILED DESCRIPTION

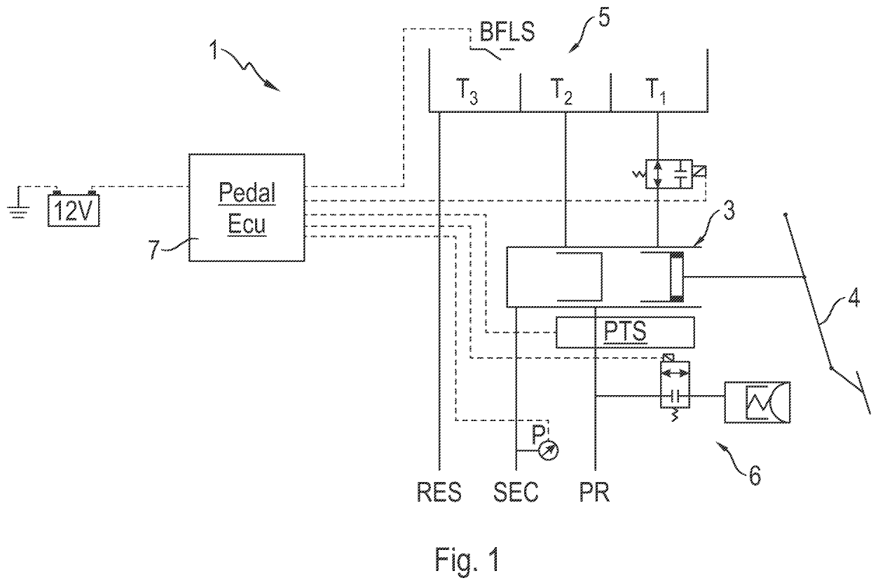

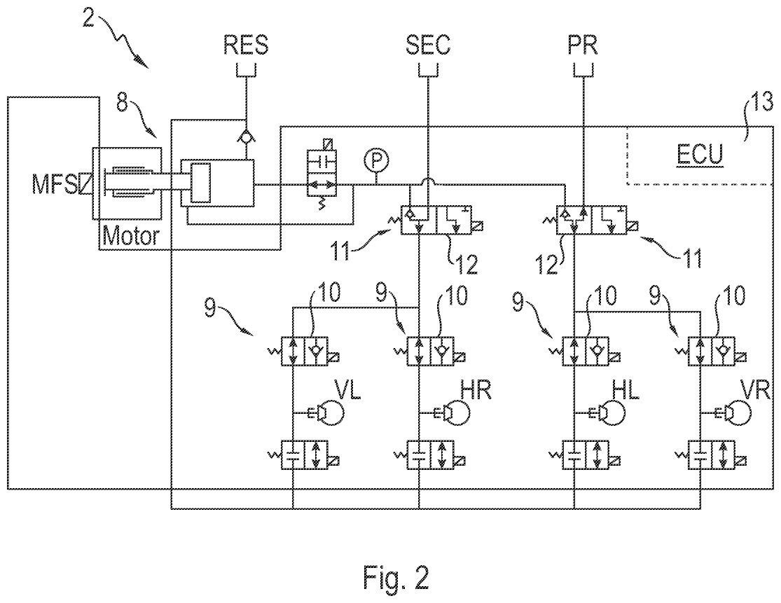

FIG. 1 schematically shows a pedal module 1 for a hydraulic motor vehicle brake system that can be operated in a brake-by-wire mode and a push-through mode. In addition to the pedal module 1, the brake system comprises a functional module 2. The functional module will be described in more detail on the basis of FIG. 2. The pedal module 1 and the functional module 2 are arranged separately from one another, for example in decentralized fashion, in the motor vehicle and are couplable and/or coupled to one another via fluid lines. The functional module 2 is arranged so as to act between the pedal module 1 and the wheel brakes VL, HR, HL, VR.

The pedal module 1 has a master cylinder 3 which, in the push-through mode, is actuatable by a driver by way of a pedal 4 in order to generate a respective brake pressure at wheel brakes VL, HR, HL, VR of the motor vehicle. The pedal module 1 may be configured to implement a brake pressure at each wheel brake, for example on a wheel-specific basis, in a redundant manner in relation to the functional module 2.

The pedal module 1 has a reservoir 5, such as a hydraulic fluid reservoir, for storing a hydraulic fluid, which reservoir is divided into three partial reservoirs T1, T2, T3. Furthermore, the pedal module 1 has a pedal simulator arrangement 6 that is connected to the master cylinder 3. The pedal simulator arrangement 9 is configured to convey a pedal reaction behaviour to the driver in the event of hydraulic decoupling of the master cylinder 3, in the brake-by-wire mode.

The pedal module 1 comprises a first controller 7 (ECU) that is configured to identify a functional failure of the functional module 2 and thereupon initiate a switch from the brake-by-wire mode to the push-through mode. The first controller 6 of the pedal module 1 are furthermore configured to, in the event of a failure of the functional module 2, switch from the brake-by-wire mode to a push-through mode, switch a second valve device of the functional module 2 such that the master cylinder 3 of the pedal module 1 is coupled to the wheel brakes VL, HR, HL, VR.

FIG. 2 schematically shows the functional module 2, which is configured as a pressure modulation module.

The functional module 2 has at least one electrical brake pressure generator 8 by which, in the brake-by-wire mode, a respective brake pressure can be generated at the wheel brakes VL, HR, HL, VR. In one exemplary arrangement, the functional module 2 is configured to generate a respective brake pressure at the wheel brakes VL, HR, HL, VR on a wheel-specific basis, for example by the electrical brake pressure generator 8.

The functional module 2 comprises one first valve device 9 per wheel brake VL, HR, HL, VR, with at least one first valve 10. In the present exemplary arrangement, four first valve devices 9 with in each case one first valve 10 are provided. The first valve devices 9 can, in an electrically non-activated state, connect the wheel brakes VL, HR, HL, VR assigned thereto to an outlet of the electrical brake pressure generator 8 of the functional module 2 and, in an electrically activated state, separate said wheel brakes from the outlet of the electrical brake pressure generator 8 of the functional module 2.

The functional module 2 furthermore comprises two second valve devices 11 with in each case at least one second valve 12. The second valve devices 11 are configured to selectively couple the master cylinder 3 of the pedal module 1 and the electrical brake pressure generator 8 of the functional module 2 to the wheel brakes VL, HR, HL, VR.

The functional module 2 furthermore has a second controller 13 (ECU). The first controller 7 of the pedal module and the second controller 13 of the functional module 2 are implemented as separate control units. The second controller 13 of the functional module 2 is configured identify a functional failure of the functional module 2 and thereupon initiate a switch from the brake-by-wire mode to the push-through mode. For example, the second controller 13 of the functional module 2 is configured to, in the event of a failure of the functional module 2, for a switch from the brake-by-wire mode to the push-through mode, switch the second valve devices 11 of the functional module 2 such that the master cylinder 3 of the pedal module 1 is coupled to the wheel brakes VL, HR, HL, VR.

Otherwise, reference is additionally made to FIG. 1 and the associated description.

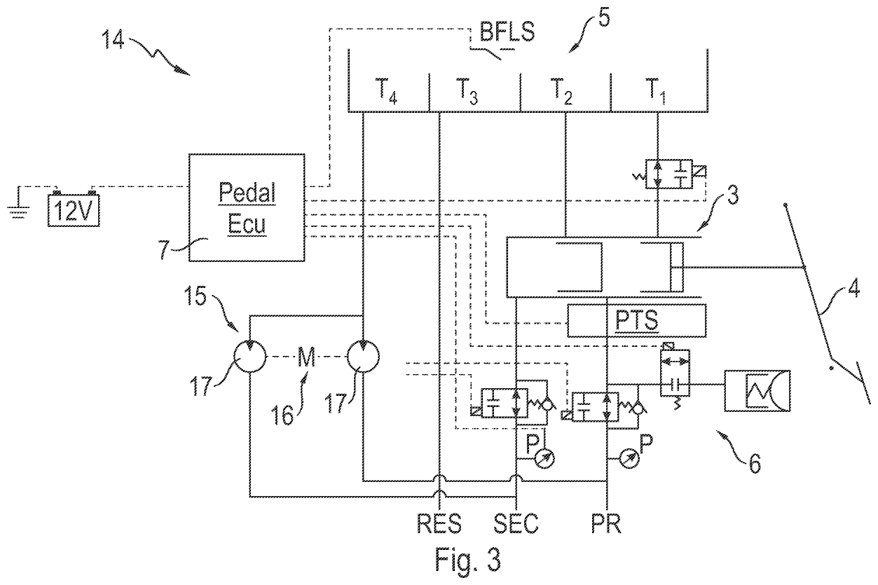

FIG. 3 schematically shows a variant of a pedal module 14. The pedal module 14 corresponds substantially to the pedal module 1 as per FIG. 1, but additionally has a fourth partial reservoir T4 and an electrical brake pressure generator 15.

The electrical brake pressure generator 15 of the pedal module 14 is configured to generate a respective brake pressure, for example on a wheel-specific basis, at the wheel brakes VL, HR, HL, VR. Furthermore, the pedal module 14 and/or the electrical brake pressure generator 15 of the pedal module 14 is configured to generate a respective brake pressure at the wheel brakes VL, HR, HL, VR independently of the master cylinder 3 of the pedal module 14 and/or independently of the functional module 2 and/or the electrical brake pressure generator 8 of the functional module 2.

The electrical brake pressure generator 15 of the pedal module 14 has at least one, in this case two, fluid-conveying devices 17 that is/are actuatable by an electric motor 16. The fluid-conveying devices 17 are for example configured as piston pumps, such as radial piston pumps.

Otherwise, reference is additionally made to FIGS. 1 to 2 and the associated description.

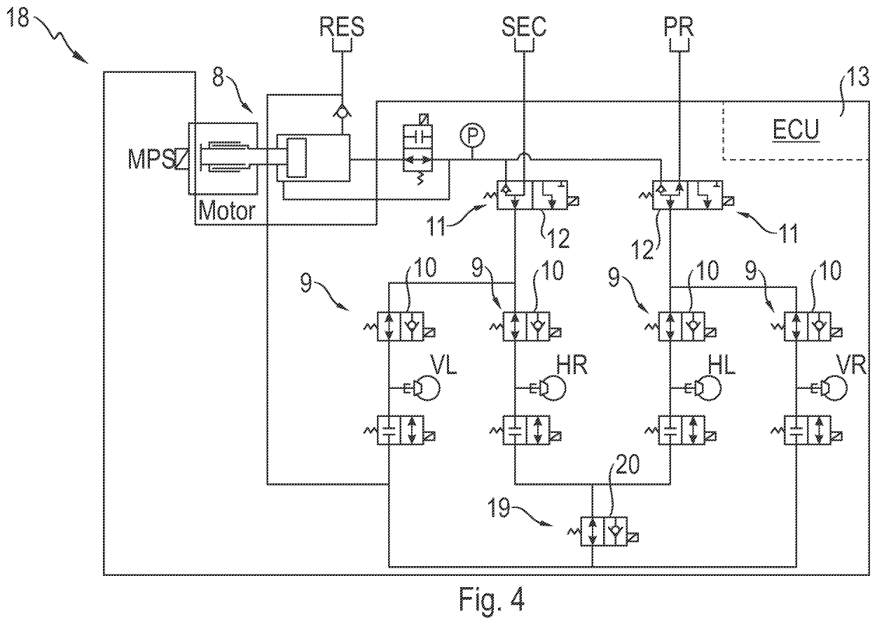

FIG. 4 schematically shows a variant of a functional module 18. The functional module 18 corresponds substantially to the functional module 2 as per FIG. 2, but additionally has a third valve device 19 with at least one third valve 20. The third valve device 19 is configured to generate brake pressure blending and/or wheel blending, for example 1-wheel blending and/or 2-wheel blending and/or 4-wheel blending.

Otherwise, reference is additionally made to FIGS. 1 to 3 and the associated description.

The word “may” is used in particular to refer to optional features of the disclosure. Accordingly, there are also refinements and/or exemplary arrangements of the disclosure that additionally or alternatively have the respective feature or the respective features.

If necessary, isolated features may also be picked out from the combinations of features disclosed here and used, with the elimination of any structural and/or functional relationship that exists between the features, in combination with other features for the purposes of delimiting the claimed subject matter.

1. A hydraulic motor vehicle brake system that is operable in a brake-by-wire mode and/or a push-through mode, wherein the brake system comprises:
a pedal module having a master cylinder which, in the push-through mode, is actuatable by a driver by way of a pedal in order to generate a respective brake pressure at wheel brakes of the motor vehicle; and
a functional module having at least one electrical brake pressure generator by which, in the brake-by-wire mode, a respective brake pressure can be generated at the wheel brakes,
wherein the pedal module and the functional module are arranged separately from one another and are couplable and/or coupled to one another via fluid lines.

2. The hydraulic motor vehicle brake system according to claim 1, wherein the hydraulic motor vehicle brake system and/or the functional module is configured to generate a respective brake pressure at the wheel brakes on a wheel-specific basis.

3. The hydraulic motor vehicle brake system according to claim 1, wherein the pedal module has a pedal simulator arrangement that is connected to the master cylinder.

4. The hydraulic motor vehicle brake system according to claim 3, wherein the pedal simulator arrangement is configured to convey a pedal reaction behaviour to a driver in an event of hydraulic decoupling of the master cylinder.

5. The hydraulic motor vehicle brake system according to claim 1, wherein the pedal module has a first controller and the functional module has a second controller.

6. The hydraulic motor vehicle brake system according to claim 5, wherein the first controller and the second controller are implemented as separate control units.

7. The hydraulic motor vehicle brake system according to claim 1, wherein the functional module is arranged so as to act between the pedal module and the wheel brakes.

8. The hydraulic motor vehicle brake system according to claim 1, wherein the functional module comprises a first valve device per wheel brake with at least one first valve, wherein the first valve device, in an electrically non-activated state, connects the wheel brake assigned thereto to an outlet of the electrical brake pressure generator of the functional module and, in an electrically activated state, separates said wheel brake from the outlet of the electrical brake pressure generator of the functional module.

9. The hydraulic motor vehicle brake system according to claim 1, wherein the functional module comprises a second valve device with at least one valve, wherein the second valve device is configured to selectively couple the master cylinder of the pedal module to, or decouple said master cylinder from, the wheel brakes.

10. The hydraulic motor vehicle brake system according to claim 1, wherein the second valve device of the functional module is configured to selectively couple the master cylinder of the pedal module and/or the electrical brake pressure generator of the functional module to the wheel brakes.

11. The hydraulic motor vehicle brake system according to claim 1, wherein the first controller of the pedal module and/or the second controller of the functional module is configured to identify a functional failure of the functional module and thereupon initiate a switch from the brake-by-wire mode to the push-through mode.

12. The hydraulic motor vehicle brake system according to claim 1, wherein the first controller of the pedal module and/or the second controller of the functional module is configured to, in the event of a failure of the functional module, for a switch from the brake-by-wire mode to the push-through mode, switch the second valve device of the functional module such that the master cylinder of the pedal module is coupled to the wheel brakes.

13. The hydraulic motor vehicle brake system according to claim 1, wherein the functional module is configured to generate brake pressure blending and/or wheel blending.

14. The hydraulic motor vehicle brake system according to claim 13, wherein the function module comprises a third valve device with at least one third valve, wherein the third valve device is configured to generate the brake pressure blending and/or wheel blending.

15. The hydraulic motor vehicle brake system according to claim 1, wherein the pedal module has, or is couplable and/or coupled to, a reservoir, for storing a hydraulic fluid.

16. The hydraulic motor vehicle brake system according to claim 1, wherein the pedal module is configured to implement a brake pressure at each wheel brake, on a wheel-specific basis, in a redundant manner in relation to the functional module.

17. The hydraulic motor vehicle brake system according to claim 1, wherein the pedal module has an electrical brake pressure generator or is configured to implement a respective brake pressure at the wheel brakes.

18. The hydraulic motor vehicle brake system according to claim 1, wherein the pedal module and/or the electrical brake pressure generator of the pedal module is configured to generate a respective pressure at the wheel brakes independently of the master cylinder of the pedal module and/or independently of the functional module and/or the electrical brake pressure generator of the functional module .

19. The hydraulic motor vehicle brake system according to claim 17, wherein the electrical brake pressure generator of the pedal module comprises at least one, fluid-conveying device(s), such as (a) piston pump(s) and/or radial piston pump(s) and/or gear pump(s) and/or multi-piston pump(s), which is/are actuatable by an electric motor.

20. The hydraulic motor vehicle brake system according to claim 17, wherein the electrical brake pressure generator of the pedal module comprises at least one single-acting or double-acting cylinder-piston arrangement that is actuatable by an electric motor.

21. The hydraulic motor vehicle brake system according to claim 1, wherein the pedal module is accommodated entirely or at least partially in a first housing block, and the functional module is accommodated entirely or at least partially in a second housing block, which differs and/or is separate from the first housing block.

22. The hydraulic motor vehicle brake system according to claim 21, wherein the functional module and/or the second housing block comprises connections for the wheel brakes.
